(19) United States
(12) Patent Application Publication
(10) Pub. No.: US 2024/0037544 A1
(43) Pub. Date: Feb. 1, 2024

(54) CLOUD-BASED TRANSACTION PROCESSING

(71) Applicant: NCR Corporation, Atlanta, GA (US)

(72) Inventor: Robert Michael Dolezal, Buford, GA (US)

(21) Appl. No.: 17/877,182

(22) Filed: Jul. 29, 2022

(51) Int. Cl. G06Q 20/38; G06Q 20/14; G06Q 20/02

(52) U.S. Cl. CPC G06Q 20/3829; G06Q 20/14; G06Q 20/02

(57) ABSTRACT

An invoice-centric, payee-centric, and/or payer-payee neutral transaction service is provided. Subsets of the transaction data for the transaction can be received separately from the parties to the transaction. The subsets of transaction data are linked to the transaction and containerized within a hierarchy. Each container within the hierarchy can include its own separate and independent encryption, encoding, and/or access rights. An invoice associated with the transaction is presented to a payer for approval before the transaction is processed, and upon payer approval, the transaction is processed on behalf of the parties using one or more selected containers from the hierarchy. Both the payee and payer may be notified when the transaction is completed.

### BACKGROUND

Electronically processed transactions have diverse purposes: submitting payments, accessing information, managing information, etc. In addition to the parties involved in a transaction, third parties often perform various functions as well such as transferring funds between the transacting parties, transferring information between parties, storing information associated with the transaction, etc.

The workflow associated with an electronic transaction is largely based on and correspondingly constrained by long-standing models associated with the transaction. For example, modern commerce transactions are based on a model that entails a payer sharing credit/account details with a payee for purposes of transferring funds from an account of the payer to an account of the payee. This payer-centric model is susceptible to a variety of forms of fraud because anyone that obtains the payer's account information can use funds of the account to perform unauthorized transactions without the payer's knowledge and consent.

A plethora of technology is continuously being deployed within the industry to detect, minimize, report, and prevent this type of fraud. Existing fraud prevention technology, however, suffers from a number of technical drawbacks, technical solutions to which are disclosed herein.

### SUMMARY

In various embodiments, methods and a system for transaction processing are presented. An invoice-centric transaction processing service is provided. Subsets of transaction data necessary for processing a transaction may be separately sent by each party of the transaction to the transaction processing service, which links the received subsets of transaction data to the transaction. A payer of the transaction is asked to confirm an invoice submitted by the payee before the transaction is processed on behalf of the parties. The subsets of transaction data may be containerized within a hierarchy for the transaction data as a whole. Each container of data may have its own encoding, encryption, and security. Access to the containers can be selectively controlled such that each party can only access information that it is authorized to access. Furthermore, only the information necessary for processing payment of a transaction may be used by the transaction processing service to process the transaction.

According to an aspect, a method of providing and operating a transaction processing service is presented. Transaction data associated with parties to a transaction is received. The transaction data is parsed into a hierarchy of containers and the transaction is processed on behalf of the parties using the transaction data corresponding to select containers within the hierarchy.

### BRIEF DESCRIPTION OF THE DRAWINGS

FIG. 1A is a diagram of workflows for providing and operating a transaction processing service, according to an example embodiment.

FIG. 1B is a schematic block diagram of a system for providing the workflows of FIG. 1A, according to an example embodiment.

FIG. 2A is a flow diagram of a method of providing and operating a transaction processing service, according to an example embodiment.

FIG. 2B is a flow diagram of example embodiments of the method of FIG. 2A.

FIG. 2C is a flow diagram of additional example embodiments of the method of FIG. 2A.

FIG. 3A is a flow diagram of another method of providing and operating a transaction processing service, according to an example embodiment.

FIG. 3B is a flow diagram of example embodiments of the method of FIG. 3A.

FIG. 3C is a flow diagram of additional example embodiments of the method of FIG. 3A.

### DETAILED DESCRIPTION

The payer-centric model—the paradigm that modern commerce transactions adhere to—is susceptible to a variety of forms of fraud because anyone that obtains a payer's account information can then use funds of the payer's account to perform unauthorized transactions without the payer's knowledge and consent. While various fraud prevention technologies have been developed to combat this sort of fraud, it is difficult for these technologies to keep pace with bad actors who are continually developing their own technologies designed to subvert the fraud prevention technologies. That is, often, as soon as a new fraud prevention technology/functionality is developed to address a particular security flaw, bad actors develop a new technology that exposes another security flaw. As a result, enterprises have to continuously roll out new hardware devices, improvements to hardware devices, and/or software updates for their security systems to address new security flaws that are continually being exposed.

Also, while some payer-centric transaction technologies can be performed in a manner that hides the payer's account information on specific devices or at specific locations, there are still many situations for the payer which require sharing such information during transactions not associated with the technology. For example, providing a payment card to a waiter for payment at a restaurant, purchasing a painting from an artist at a street fair, using a specific website to make an online purchase, or simply losing a wallet/bag that contains the payer's payment card.

Increasingly thieves are modifying and improving hardware and software devices and their techniques to penetrate payer-centric transaction technologies. For example, a thief may place a skimmer device within a card reader to steal magnetic encoded account information off of a payment card when the card is placed in the card reader. Chip-integrated cards and chip-enabled card readers were developed to combat such skimmer devices. In response, however, thieves developed shimmer devices. A shimmer device is similar to a skimmer device but smaller in size (paper thin and virtually undetectable from visual inspection of the card readers) and capable of not only stealing magnetic encoded account information, but also chip-encoded account information from chip-enabled card readers.

The sophistication of skimmers and shimmers can vary. For instance, some skimmers/shimmers are capable of wirelessly transmitting the stolen account information to a nearby device of the thief or to a thief-controlled website, while others do not possess wireless communication capabilities. A skimmer/shimmer may also store the stolen account information on memory of the device or on a memory card of the device such that the thief can retrieve the stolen account information when the device is retrieved from the card reader.

The payer-centric model also suffers from other drawbacks beyond the security concerns. For instance, a payer has to rely on the payee's confirmation that a payment was successfully completed for the correct amount. Further, detailed information or related information for the transaction (e.g., itemized receipts, product warranties, rebate information, usage instructions, general contract terms, coupons, advertisements, dosing guidelines (for pharmaceuticals), payee return policies, etc.) is often not available, nor is it linked to anything available to the payer after that transaction is completed. In general, a payer's financial institution only retains basic transaction details made available by a payee or a third-party.

Embodiments of the technology disclosed herein provide an invoice-centric transaction processing service that provides technical solutions to the above-noted technical problems associated with conventional payer-centric models. According to the invoice-centric transaction processing service according to embodiments of the disclosed technology, payers are able to share invoice-only account identifiers with payers without the risk of compromising the payers' private account data. Invoice-only account identifiers can be public and readily sharable with anyone. Invoice-only account identifiers are unlikely to induce widespread criminal behavior because a payer has an opportunity to review an invoice before submitting payment to the payee who generated/transmitted/posted the invoice, and thus, unexpected invoices are unlikely to be approved by the payer.

In example embodiments, after having obtained a payee's invoice, which may include the payee's public and receivables-only account identifier, a payer can then execute the transaction by providing the payee's public account information, the payer's private account information, a transaction identifier, a dollar amount, and other data to a trusted transaction clearinghouse such as a bank, a credit union, or other transaction processing company. This transaction processing service may be a trusted service that is trusted by both by the payer and the payee to securely convey designated funds to the payee using a financial network.

Because the payer's private account information is never shared with payees in an invoice-centric transaction processed according to the invoice-centric transaction model disclosed herein, the payer's private account information is much more secure than in a conventional, payer-centric transaction. As such, the invoice-centric transaction processing service and model disclosed herein represents a technical improvement with respect to transaction security over conventional, payer-centric transactions and provides a technical solution that substantially reduces the incidence of fraud in such transactions. This, in turn, provides a technical benefit to both payer and payee alike, in the form of reduced processing fees and more efficient commerce, for example.

Additionally, the transaction processing service according to embodiments of the disclosed technology permits payers and payees to separately and independently submit details or subsets of their transaction data for a given transaction to the transaction processing service. The transaction processing service is configured to link the separately submitted subsets of transaction data to the transaction. The subsets of transaction data may also be containerized when sent to the transaction processing service, such that portions or containers of the overall transaction data can be grouped into chunks or portions by the transaction processing service and referenced independently, encrypted, and included or omitted in processing steps of the transaction. Automatic notifications may be provided to neutral third parties to a given transaction and used to confirm completion of steps of the transaction. Various key information, such as dollar amount of a payment, can be encoded by the transaction processing system in different manners in multiple parts of a hierarchy of the containers for purposes of fraud prevention (a “hierarchy of containers” may refer to modular data in at least some aspects of the disclosed technology). The transaction processing service may include sufficient information so as to prevent parties to a transaction from accessing and downloading information that is neither shared nor decryptable. Each of these above-described aspects of the transaction processing service disclosed herein provide, individually and in combination, a technical solution to the problem of transaction fraud that would otherwise occur in transactions processed according to a payer-centric model.

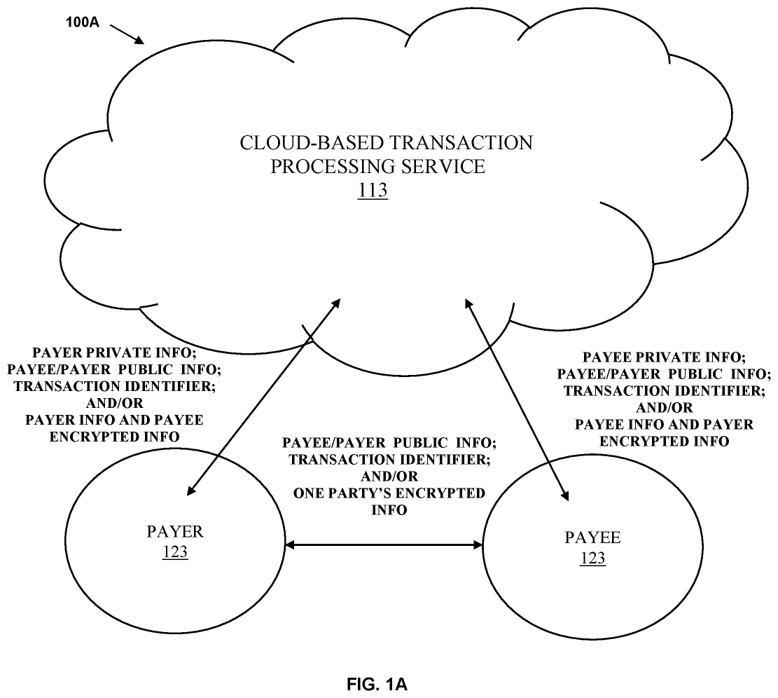

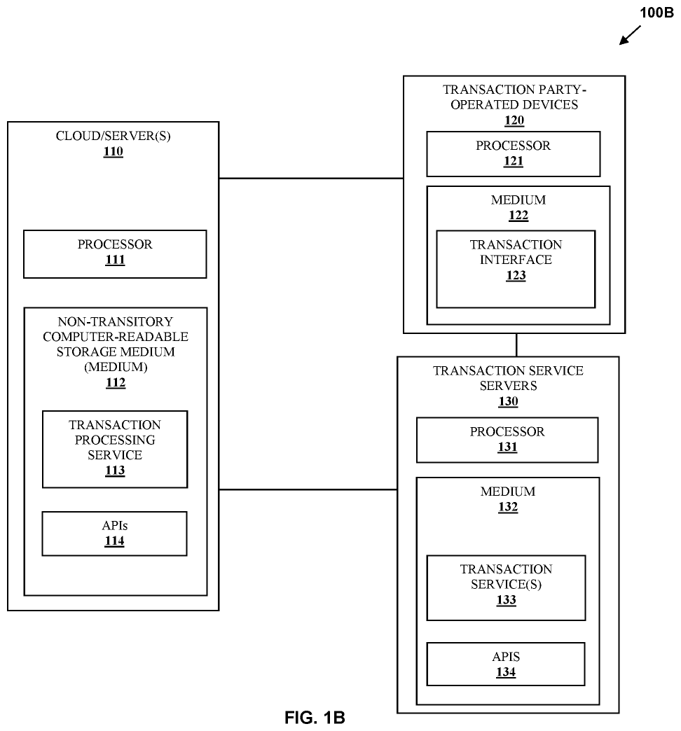

FIG. 1A is a diagram depicting a networked architecture 100A that includes a cloud-based transaction processing service 113 and transactions interfaces 123 that a payer and a payee utilized to communicate with the transaction processing service 113. FIG. 1A further depicts various processing flows/workflows and transaction data passed between the transaction processing service 113 and the payer and payee.

Three workflows are illustrated. A first workflow entails a payee providing public information or a public receivables-only account identifier to the payer to initiate payment for a transaction. The first workflow also supports the payer providing the payee an invoice-only public account identifier when a final invoice for the payer is not finalized such as when the payer is running an open tab with the payee, when a payer receives monthly utility bills from a payee that is a utility company, and/or any other type of one-time or recurring invoice scenario in which the invoice is not finalized for the payer until the invoice is generated and submitted by the payee. In example embodiments, at no time does the payer disclose private account information to the payee nor does the payee disclose private account information to the payer. Both the payee and payer separately provide the public account information for the other party and private account information for themselves to the transaction processing service 113. Transaction processing service 113 collects the transaction data for the transaction and presents an invoice for review to the payer. Payee may also directly submit the invoice to the payer. Payer authorizes the payment of the invoice and transaction processing service 113 processes the transaction payment from the payer to the payee utilizing a financial network associated with the financial institutions (FI) of the parties.

In a second workflow, the payer and payee do not exchange any account identifiers or information to the other party during a transaction. Rather, the payer obtains a unique transaction identifier from the payee and separately sends the transaction identifier to the transaction processing service 113. Simultaneously, payee submits transaction data and the transaction identifier to the transaction processing service 113 along with an invoice for the transaction. Transaction processing service 113 associates the received invoice with the appropriate payer by linking the respective transaction identifiers received from the payer and the payee to the invoice provided by the payee, and submits the invoice to the payer for approval. Once the invoice is approved by the payer, transaction processing service 113 processes the transaction payment from the payer to the payee utilizing a financial network associated with the (financial institutions) FIs of the parties.

In a third workflow, one party transmits the transaction data to the transaction processing service 113 after receiving from the other party an encrypted subset of transaction data that it is unable to decrypt. In example embodiments, the transaction processing service 113 is capable of decrypting the encrypted subset of transaction data for purposes of processing the transaction, but the party transmitting the encrypted subset of data is not capable of decrypting it.

FIG. 1B is a diagram of a example system 100B for providing and operating a transaction processing service configured to implement the example workflows of FIG. 1A. It is to be noted that the components are shown schematically in greatly simplified form, with only those components relevant to understanding of the embodiments being illustrated. Furthermore, the various components depicted in FIG. 1B and their arrangement is illustrative and not exhaustive. It is to be noted that other arrangements with more or fewer components are possible without departing from the teachings of providing and operating a transaction processing service according to embodiments of the disclosed technology.

System 1008 provides a transaction service that facilitates and performs transactions on behalf of parties to a transaction. Parties to a transaction can submit varying subsets of their transaction data for a given transaction in separate and individualized containers to the transaction processing service 113. Some containers may include information that other parties to the transaction are restricted from viewing. Then, the transaction processing service 113 can securely send information that is needed to complete the transaction to the appropriate corresponding transaction service. In example embodiments, system 100B operates under a payee-centric and/or under a payer/payee neutral transaction processing model. For instance, in various embodiments, system 100B operates according to a public payee-centric model, a secure payer-centric model, and/or a payee/payer neutral model.

A “service” is a one or more sets of cooperating executable instructions that perform transactions between two or more parties using one or more resources. A “resource” is a data asset associated with a given party to the transaction and represented in a data model. For example, a resource may be a financial account, social media account, or other service-based account. A “transaction” accesses on one or more of the resources to obtain or to update data values (information) associated with the resources. The resource may be accessed to obtain data values (with no changes) or to update data values associated with one or more fields of one or more resources. For example, a financial service performs a financial transaction on behalf of a payer to pay a payee in a financial transaction. The financial service accesses the financial account (financial resource) of the payer to transfer funds to a financial account (financial resource) of the payee.

An “owner” is an individual or other entity (enterprise) that controls one or more resources. An owner may include a consumer or an enterprise such as a retailer, a government agency, or a non-profit/profit-based organization.

The operations of the system 100B are now discussed within a context of a financial account (one type of resource) and financial services, but it is to be understood that the type of resource and the type of service may include many different types, such as a social media account associated with a social media service, an entertainment account associated with an entertainment service, a retailer or travel-based account associated with a retailer or travel-based service, or any other service-based account and corresponding service-based account service that collects, retains, and/or performs transactions on information associated with a user of that service. It is within this context the system 100B is discussed with reference to FIG. 1B.

System 100B includes at least one cloud/server 110, transaction party-operated devices 120, and transaction service servers 130. Cloud/server 110 includes at least one processor 111 and a non-transitory computer-readable storage medium 112. Medium 112 includes a transaction processing service 113 and Application Programming Interfaces (APIs) 114, each of which includes executable instructions, that when executed by processor 111, cause processor 111 to perform corresponding operations discussed herein and below with respect to 113 and 114.

Each transaction party-operated device 120 (hereinafter “party-operated device 120”) includes at least one processor 121 and a non-transitory computer-readable storage medium 122. Medium 122 includes a transaction interface 123 that includes executable instructions, which when executed by processor 121, cause processor 121 to perform corresponding operations discussed herein and below with respect to 123.

Each transaction service server 130 includes at least one processor 131 and a non-transitory computer-readable storage medium 132. Medium 132 includes one or more transaction services 133 and APIs 134, each of which includes executable instructions, that when executed by processor 131, cause processor 131 to perform corresponding operations discussed herein and below with respect to 133 and 134.

System 1006 may be configured to process transactions in scenarios where parties to a transaction exchange public or encrypted account identifiers with one another and in scenarios where only a transaction identifier is needed for the parties to complete a transaction with transaction processing service 113. Additionally, the types of transaction data exchanged by the parties with transaction processing service 113 to complete a given transaction can vary.

In some embodiments, transaction processing service 113 receives 1) a payer account identifier (which can be an disbursements-only account identifier that has limited public sharing by the payer or can be a private account identifier of the payer) that is being used by the payer to pay for a transaction, 2) a payee account identifier (which can be a receivables-only account identifier that is publicly shared by the payee or can be a private account identifier of the payee) that is being used by the payee to receive funds from the payer, and 3) a payment amount specified by one of the payee or the payer and/or specified by both the payer and the payee. In some embodiments, the above-noted transaction identifiers and data may represent a minimal amount of information needed for the transaction processing service 113 to process the corresponding transaction. It should be appreciated that the format in which the transaction data is received can vary such that each party may employ the same or different encryption protocols.

The transaction data provided by each party can also include additional transaction-related details, which can be custom set by each party with the transaction processing service 113. The payee may provide an invoice-specific level of detail associated with the transaction as well as ancillary data related to products and services associated with the invoice-specific level of detail. Each party may provide different confidential information, which the corresponding party does not want to share with the other party, such as contact information or contact details.

A warranty associated with an item being purchased is an example of content-rich information that a payee may provide to the transaction processing service 113 in connection with a transaction. The warranty may be provided, for example, as a link to a website of the payee that includes a warranty document, or the warranty may be provided as a document directly accessible via the transaction processing service 113. One of ordinary skill in the art will readily appreciate that the ability to retain warranty information that is linked to a given transaction is a long felt need of consumers, which system 1008 has solved via transaction processing service 113. The ancillary data related to products and services may also include other types of information beyond just warranty information such as rebate information, itemized receipts, contract terms/information, coupons, advertisements, usage instructions, dosing guidelines for pharmaceuticals, return policies, etc.

The respective subset of transaction data received from each of the parties combines to form the transaction data that is managed by the transaction processing service 113. Each of one or more portions of the subset of transaction data received from each party may be associated with a corresponding container or group. For instance, in some embodiments, the transaction processing service 113 may associate each container or group with a specific type of information received from just one party or received separately from each party. For example, the transaction processing service 113 may separately receive a respective payment amount from each party and may allocate a single payment container to the transaction data cumulatively received from both parties. For example, the single payment container may include an identifier for the payer, the payer-provided payment amount, an identifier for the payee, and the payee-provided payment amount.

The transaction processing service 113 may manage the containers according to a hierarchy associated with the containers. The transaction processing service 113 generates the invoice. For example, a top-level container may be identified as a transaction detail container that, in turn, includes various lower-level containers. The transaction processing service 113 may traverse the hierarchy to retrieve various transaction data from the lower-level containers including, for example, a transaction identifier for the transaction, respective entity identifiers for the payer and payee, a store identifier for any store of the payee where the transaction was initiated, a transaction date, a geographic location associated with the transaction, any terminal identifier for a terminal that generated an invoice, the invoice details, the payer's account identifier for providing payment, the payee's account identifier for receiving payment, and a payment amount for the transaction.

By using separate containers within a hierarchy of containers to manage the subsets of transaction data, transaction processing service 113 may enforce custom-access restrictions. For example, a container associated with the payer's contact information (e.g., a phone number, an email, home address, etc.) may have a corresponding security setting that prevents the payee from accessing that information if the payee requests the payer contact information through transaction interface 123. Similarly, the payee's contact information may be restricted such that the payer cannot obtain personnel names and contact information associated with the payee from the transaction processing service 113. Account identifiers held in a private account container may also not be shared between the parties. As another example, although the payer may provide, on an as-needed basis, a limited shared invoices-only account identifier for a given transaction, the payee may be restricted from viewing the invoices-only account identifier used with the transaction. It is noted that these are but a few examples. The degree to which access is restricted can be customized by the parties with transaction processing service 113.

Additionally, the transaction processing service 113 may natively store content associated with some containers in an encrypted format without disclosing the decryption key to any party associated with a given transaction. This allows the transaction processing service 113 to store key information associated with a given transaction, such as a dollar amount due or paid, in a secure fashion to prevent fraud.

The subsets of transaction data may also be provided to the transaction processing service 113 in an encrypted data stream that is specific to each of the parties, such that only the transaction processing service 113 is capable of decrypting the data stream to process the corresponding subset of transaction data into the containers. For example, the payer may utilize its private key and a public key of the transaction processing service 113 to encrypt a subset of transaction data, which may then be sent as an encrypted data stream to the transaction processing service 113 via the transaction interface 123 of the payer. The transaction processing service 113 may then utilize its private key and a public key of the payer to decrypt the encrypted data stream and parse the decrypted data stream into the appropriate containers within a container hierarchy for a given transaction.

Similarly, the payee may encrypt its subset of transaction data with its private key and a public key of the transaction processing service 113 and may send the encrypted data stream to the transaction processing service 113 via the payee's transaction interface 123. The transaction processing service 113 may then use its private key and the public key of the payee to decrypt the encrypted data stream and parse the decrypted data stream into the appropriate containers within the container hierarchy for the corresponding transaction.

In some embodiments, the top-level container may be the transmission stream itself, which has to be encrypted by the sender and which is decryptable by the receiver. Subsidiary containers may be encrypted by the originator of that container and decryptable by some subset of the parties and/or mediators of the transaction (possibly by the sender). For example, a payer may encrypt a private account identifier that the payee cannot decrypt, but which payee can forward to the transaction processing service 113, which in turn, can decrypt the account identifier to facilitate payment for the transaction.

In an embodiment, once the payer approves an invoice and the transaction processing service 113 processes the approved invoice, the service 113 does not retain unencrypted invoice details for the transaction in storage. The original invoice details may be stored in an encrypted format that one or more of the parties are capable of decrypting for a configurable period of time after the transaction is processed. In some embodiments, a third-party transaction service 133 may hold the decryption keys in escrow for the parties and the keys may expire after the configurable period of time elapses. In other embodiments, the transaction processing serviced 113 may hold the decryption keys in escrow for the parties.

In an embodiment, the transaction processing service 113 removes each container hierarchy for a given transaction from storage after a configurable period of time. The period of time may be set by the parties and/or by the transaction processing service 113. For example, the configurable period of time may be set by the parties for a period of one year. Absent any configurable period of time set by the parties, the transaction processing service 113 may set the configurable period of time (e.g., three years, seven years, etc.).

In an embodiment, when the two parties separately send their subsets of transaction data to the transaction processing service 113, there is a chance that one of the parties fails to timely send their subset of transaction data. In these cases, the received subset of transaction data may be archived or deleted after a configurable period of time.

In an embodiment, the payee directly provides the invoice to the payer without utilizing the transaction processing service 113. In such scenarios, transaction interface 123 permits payer authorization to be provided to the transaction processing service 113 after the payer has viewed and approved the invoice within transaction interface 123.

In an embodiment, the payer shares a disposable account alias or a single-user alias with the payee. The disposable account alias or single-user alias may be associated with a payment cap, and optionally, a time limit. In this embodiment, there is no security concern that the disposable account alias can be used a second time, and as such, security is ensured for the transaction.

In an embodiment, transaction processing service 113 performs multifactor authentication before processing a payment from a payer to a payee. In this embodiment, the payee provides a first-factor authentication via the authorization sent through the transaction interface 123 to the transaction processing service 113. In response, transaction processing service 113 initiates an automated voice call or sends a short message service (SMS) message to a phone number associated with the payer or sends an email to an email address of the payer, in response to which the payer can verify the payment amount a second time for a second-factor authentication. Only after the multi-factor authentication is confirmed does the transaction processing service 113 process the payment from the payer to the payee.

In an embodiment, transaction processing service 113 manages a single account for a given party, the single account may include multiple account aliases, each alias associated with a different type of payment mechanism such as credit card, debit card, savings account, and checking account. Each payment mechanism requires different data formats that are managed by transaction processing service 113 when performing payment processing with external services 133 associated with each payment mechanism.

In an embodiment, the subsets of transaction data sent by the parties to the transaction processing service 113 are serialized, tagged, or field-defined. For example, transaction interface 123 may transmit the subsets of transaction data to transaction processing service 113 as a stream of data that is serialized, tagged, or field-defined.

In some embodiments, transaction processing service 113 may also provide confirmations to both the payer and the payee when the transaction is completed. This is in contrast to traditional payment scenarios in which just the payee receives confirmation, and then has to relay the confirmation to the payer.

Neutral third-party transaction services 133 may provide notification services to the payer and payee when a transaction is confirmed as being completed. Transaction processing service 113 may use APIs 114 to interact with APIs 134 when completing various milestones within a transaction workflow for the payer and payee. A corresponding transaction service 133 may then provide a neutral third-party confirmation to the parties when milestones in the transaction workflow are completed.

In an embodiment, when a transaction is initiated by a payee on behalf of a payer, the payer obtains a unique transaction identifier from the payee. The transaction processing service 113 (or another cloud-based service) may generate the transaction identifier and provide it to one or more parties of the transaction. This can be done in a variety of manners. For example, a transaction terminal (e.g., device 120 of a payee) may display a Quick Response (QR) code on a display, which the payer can scan using a camera of a payer-operated device 120 (e.g., a smartphone). In response, transaction interface 123 of terminal 120 may send an invoice for the transaction to the transaction processing service 113, including the transaction identifier encoded in the QR code and a receipts-only account identifier for the payee. In addition, transaction interface 123 of payer-operated device 120 may send the transaction identifier decoded from the QR code, an invoice-only account identifier for the payer, and an invoice for the transaction, to transaction processing service 113.

Transaction processing service 113 may confirm that the two separately sent subsets of transaction data match, in particular, that the two separately received transaction identifiers match, and may proceed to parse the subsets of transaction data into various containers within the transaction container hierarchy. Transaction processing service 113 then presents the invoice for approval to the payer through the corresponding transaction interface 123 and receives payer's approval to pay the transaction. Transaction processing service 113 may obtain, from the containerized information within the hierarchy, the minimal information needed to process the transaction through a financial network (e.g., the account identifiers and total amount being paid) and may then complete the transaction on behalf of the parties. A completed notification can be sent to both the payee and the payer through the corresponding transaction interfaces 123.

In some embodiments, the QR code may be presented on a website of the payee within a web browser that presents transaction interface 123 to the payer for online transactions. It should be appreciated that a QR code is merely an example, and that the transaction identifier can be encoded in any suitable manner. Additionally, the payee may send an SMS message that includes the transaction identifier to a device 120 operated by the payer. It is noted that other existing or foreseeable mechanisms by which the payee communicates a transaction identifier to the payer (or vice versa) can be employed without departing from the teachings provided herein.

In an embodiment, the transaction processing service 113 matches an amount due and an authorized payment amount provided in separate subsets of transaction data from the payee and payer before processing the payment through the financial network of the parties. This provides additional security to ensure that the payer is only authorizing payment for what the payer has authorized.

In an embodiment, transaction processing service 113 receives a notification when a transaction service 133 associated with the financial network confirms that funds were transferred between the accounts of the parties through APIs 134 and 114. This notification can then be sent to the payer via transaction interface 123, which may be accessed via any registered notification channel associated with the payer, such as email, mobile phone number, etc.

In those embodiments in which a third-party transaction service 133 completes the payment on behalf of the payer or confirms payment on behalf of the payee, the transaction processing service 113 may use APIs 114 and 134 to instruct the third-party transaction service 133 to also send a notification to the payer when the transaction service 133 sends confirmation of payment received to payee.

In an embodiment, such as an open tab or a one-time or recurring payment of different amounts scenario, the payee submits a final invoice to transaction processing service 113. Transaction processing service 113 then provides the invoice to the payer for approval through transaction interface 133. Once approved by the payer, the transaction processing service 113 processes the payment through the financial networks of the parties.

In some embodiments, the payer shares an invoice-only account identifier, and optionally, a dollar limit (e.g., in the case of a non-final or an open invoice) with the payee, and the payee sends the invoice-only account identifier (and optionally, the dollar limit) and invoice details to the transaction processing service 113 as the details become available to the payee based on the payer's purchase activity. When updated details are received from the payee, transaction processing service 113 may provide the updated details to the payer for review through the transaction interface 123. Transaction processing service 113 may also notify the payer, through interface 123, when any dollar limit provided is within a configurable amount of being reached by the payer.

In an embodiment, the payee provides a receipts-only account identifier, an invoice, and a total amount due to the payer. In turn, the payer sends a private account identifier for the payer, the payee's receipts-only account identifier, the invoice, and the total amount due to transaction processing service 113. In this case, transaction processing service 113 may assume that payment for the invoice was authorized by the payer and may process the transaction on behalf of the parties through the financial network. In this embodiment, the invoice may also be omitted by the payer such that just the account identifiers and total amount due are received by the transaction processing service 113.

In an embodiment, payer shares an invoice-only account identifier with the payee. Payee sends a transaction identifier, the invoice-only account identifier of the payer, a receipts-only account identifier (or a private account identifier) of the payee, an invoice, and total amount due to transaction processing service 113. Transaction processing service 113 sends the invoice to the payee for review and approval. Once the invoice is approved, transaction processing service 113 processes the transaction payment through the financial network.

In an embodiment, an invoice submitted by a payee to a payer is stored by transaction processing service 113 in the container hierarchy with a checksum value or with digital signatures of the parties. This provides a mechanism by which the accuracy of the invoice details confirmed should any dispute arise between the parties following the transaction.

In an embodiment, portions of transaction processing service 113 are implemented on the transaction party-operated devices 120 to permit peer-to-peer (P2P) transactions between the parties utilizing any of the above-referenced techniques. In this embodiment, the parties can perform the transaction with any P2P connection and do not necessarily require a local area/wide area network connection.

In an embodiment, transaction processing service 113 is implemented within a server associated with an enhanced version of a P2P cash service 133 such that the parties can utilize any of the above-referenced techniques and workflows with the enhanced cash service 133 to process P2P transactions between the parties.

In an embodiment, transaction processing service 113 permits invoicing without any intervening third-party service 133 being involved with the transaction using local area or wide area connections to the cloud 110 or to a specialized device configured to obtain the invoice and transaction data on behalf of the parties and provide the same to transaction service 113 for processing.

In an embodiment, the transaction processing service 113 is used for transactions associated with any data exchanges between two or more parties. The data exchanges can be for financial transactions, transactions associated with sharing of intellectual property, transactions associated with coordinating contractual obligations, transactions associated with shareholder voting, transactions associated with non-fungible tokens (NFTs), transactions associated with personal medical information, transactions associated with sharing other confidential or private information of a user, etc.

In example embodiments, transaction processing service 113 provides an invoice-centric, payee-centric, and/or payer/payee neutral mechanism by which transactions are processed on behalf of parties to the transactions. Private account details do not have to be exchanged between the parties, transaction data is secured within a flexible container hierarchy, security of the information is maximized through varying degrees of encryption, and access rights and verified information can be provided from the container hierarchy should any disputes arise between the parties. Additionally, ancillary information related to a given transaction may be retained as content-rich information for recall by the parties, such as warranty documents, usage instructions, dosage instructions, itemized receipt, coupons, advertisements, general contract terms, rebate policies, return policies, etc. Further, payers can now receive independent notification when a transaction is successfully processed, whereas conventionally, it was just the payee that receives notice, which the payee then relayed to the payer. Select information retained in the containerized hierarchy may be stored in such a way that only the transaction processing service 113 may be capable of decrypting the information. Alternatively, information may be stored in select containers in such a way that only a certain party to the transaction (e.g., the payee or payer) is capable of decrypting the information, and the transaction processing service 113 is not capable of decrypting the information. In some embodiments, a given container may utilize a different encryption protocol than another container within the container hierarchy and hierarchical aggregations of the containers can be used to identify select information needed to process the transaction.

In an embodiment, devices 120 operated by a payee may include a point-of-sale (POS) terminal, a phone, a tablet, a laptop, a server, a desktop, or a wearable processing device. In an embodiment, devices 120 operated by a payer may include a self-service terminal (SST), a kiosk, a phone, a tablet, a laptop, a desktop, a server, or a wearable processing device.

In an embodiment, transaction processing service 113 and APIs 114 execute, at least in part, on a transaction service server 130. For example, transaction processing service 113 and APIs 114 may be provided by a financial institution associated with a given financial transaction service.

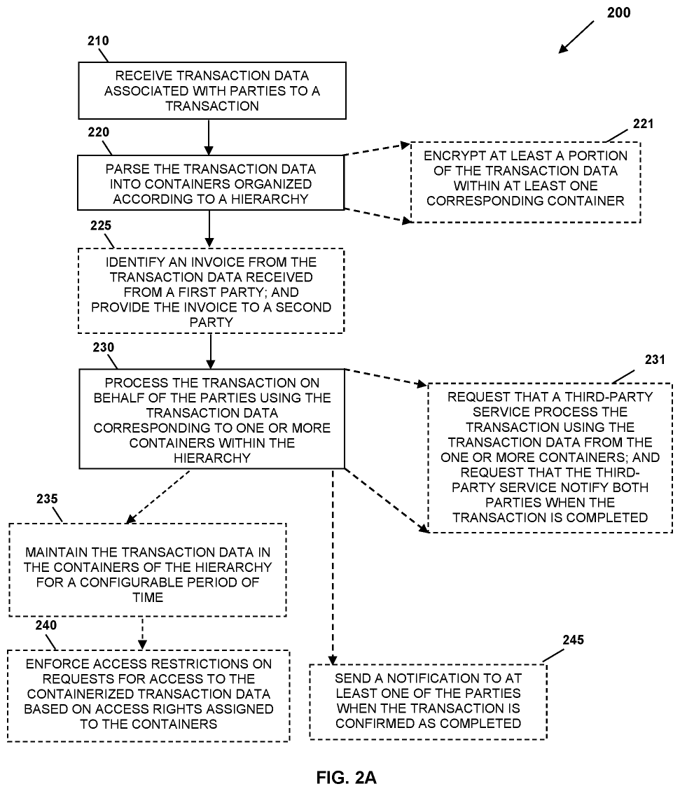

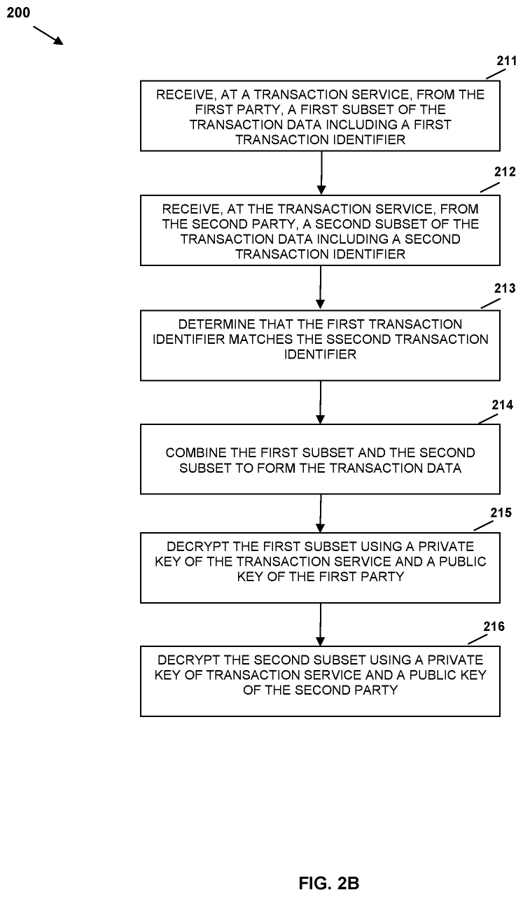

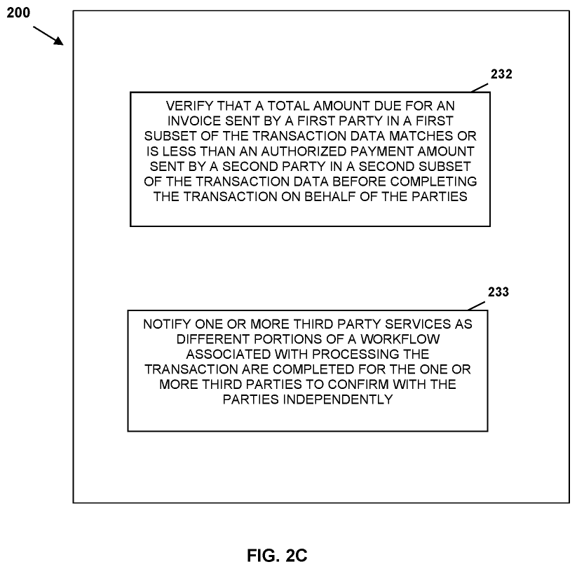

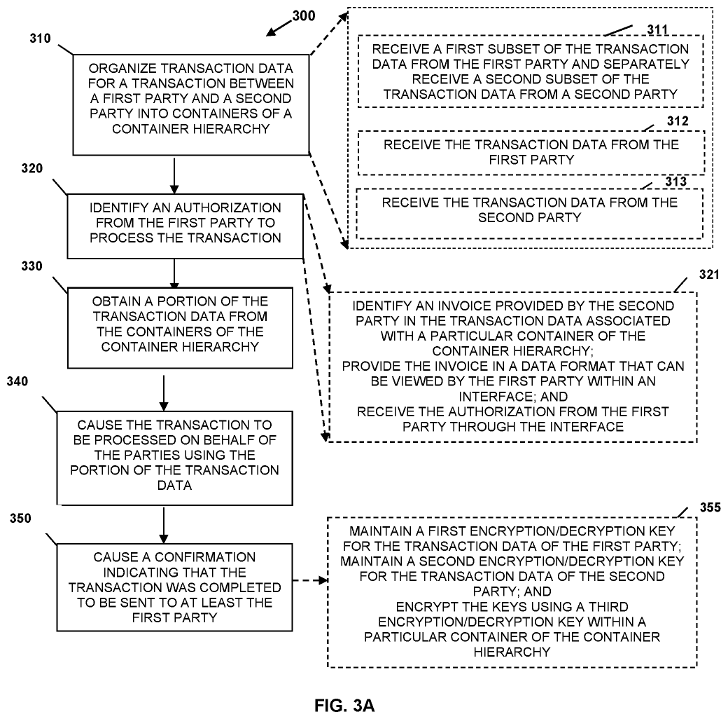

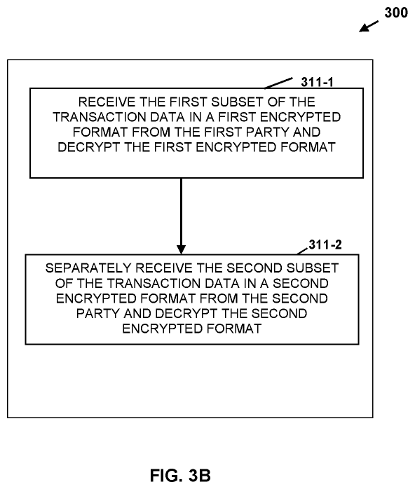

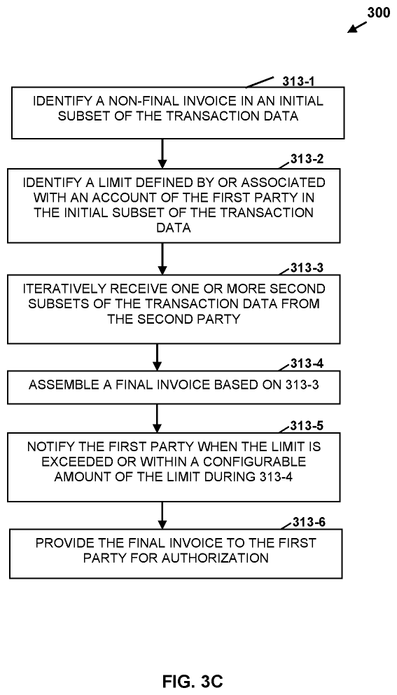

The above-referenced embodiments and other embodiments will now be discussed with reference to FIGS. 2A, 2B, 2C, 3A, 3B, and 3C. FIGS. 2A, 2B, and 2C are diagrams of a method 200 of providing and operating a transaction processing service, according to an example embodiment. The software module(s) that implements the method 200 is referred to as a “transaction service.” The transaction service is implemented as executable instructions programmed and residing within memory and/or a non-transitory computer-readable (processor-readable) storage medium and executed by one or more processors of a device or set of devices. The processor(s) of the device(s) that executes the transaction service are specifically configured and programmed to process the transaction service. The transaction service may have access to one or more network connections during its processing. The network connections can be wired, wireless, or a combination of wired and wireless.

In an embodiment, the transaction service is transaction processing service 113 executing on server 110. In an embodiment, the transaction service is one, all, or some combination of 113, 114, and 123. In an embodiment, the server 110 is one of several servers logically presenting and cooperating as a single server representing a cloud 110 or a cloud processing environment 110. In another embodiment, the device that executes the transaction service 133 is transaction service server 130.

Referring now to FIG. 2A, at 210, a transaction service receives transaction data associated with parties to a transaction. The transaction can be a financial transaction, a transaction to share intellectual property, contractual coordination, shareholder voting, trading NFTs, etc. The manner in which the transaction data is received can vary. For example, all of the transaction data may be received from just one of the parties or respective subsets of the transaction data can be received from each of the parties. Then, at 220, the transaction service parses the transaction data into containers of a hierarchy. That is, groupings and types associated with the transaction data are identified and assigned to transaction data containers that are separately managed within a hierarchy of the containers. In an example implementation, parsing the transaction data into containers may include encrypting at least a portion of the transaction data within at least one corresponding container. The encryption format/protocol used to encrypt the at least a portion of the transaction data within at least one container can be different from the encryption used for a subset of transaction data received from a party to a transaction.

FIG. 2B depicts an example implementation for the manner in which the transaction service may receive the transaction data and manipulate the received transaction data. The various operations of the example implementation of FIG. 2B may be performed as part of operation 210 (FIG. 2A), as part of operation 220 (FIG. 2A), as part of operations 210 and 220, between operations 210 and 220, or some combination thereof.

Referring now to FIG. 2B, in a particular embodiment, at 211, the transaction service receives a first subset of the transaction data from a first party. At 212, the transaction service separately receives a second subset of the transaction data from a second party. The first subset of transaction data contains a first transaction identifier and the second subset of transaction data contains a second transaction identifier. At 213, the transaction service determines that the first transaction identifier present in the first subset of transaction data matches the second transaction identifier present in the second subset of transaction data and confirms that the two subsets of transaction data relate to the same transaction based on the detected match. Then, at 214, the transaction service combines the first subset and the second subset to form the transaction data.

At 215, the transaction service decrypts the first subset of transaction data using a private key associated with the transaction service and a public key associated with the first party. At 216, the transaction service decrypts the second subset of transaction data using the private key of the transaction service and a public key associated with the second party. It should be appreciated that the operations at 215 and/or 216 may be prior or subsequent to combining the first and second subsets of transaction data.

Referring again to FIG. 2A, at 225, the transaction service may optionally identify an invoice from the transaction data received from a first party and provide the invoice to the second party. At 230, the transaction service processes the transaction on behalf of the parties using the transaction data that corresponds to select containers of the hierarchy. For example, only an account identifier for the first party, an account identifier for the second party, and a transaction amount due may be required to process the transaction such that just the respective containers that include the referenced data are accessed and used by the transaction service to process the transaction. It is noted that additional container data may be needed dependent upon any given transaction. In those embodiments in which the transaction service identifies an invoice from the transaction data received from the first party and sends the invoiced to the second party, the transaction service may wait to receive approval of the invoice from the second party prior to processing the transaction.

In a particular embodiment, at 231, processing the transaction includes the transaction service requesting a third-party service to process the transaction using the transaction data from the select containers. The transaction service may also request the third-party service to notify both of the parties when the transaction is completed by the third-party service. For example, the third-party service may be a financial institution (FI) service 133 of a seller (e.g., a payee and a first party). Conventionally, the FI service 133 may only notify the seller, but according to this embodiment of the disclosed technology, the transaction service may use APIs 114 and 134 to instruct the FI service 133 to also notify the buyer (e.g., payer and a second party). In some embodiments, the transaction service may additionally or alternatively separately interact with the FI service 133 of the buyer upon receiving notification from the FI service 133 of the seller that the transaction completed so that the buyer's FI service 133 notifies the buyer that the transaction completed.

Referring now to FIG. 2C, in a particular embodiment, at 232, the transaction service verifies that a total amount due for an invoice contained in a subset of the transaction data sent by a first party matches or is less than an authorized payment amount contained in a subset of the transaction data sent by a second party before completing the transaction on behalf of the parties. This scenario ensures that the requested amount by the first party matches what was communicated to the second party or what is otherwise expected by the second party because processing the payment from the second party to the first party requires that the total amount due is equal to or less than the authorized payment amount.

Still referring to FIG. 2C, in an embodiment, at 233, the transaction service notifies one or more third-party services as different portions of a workflow associated with processing the transaction are completed. This allows the one or more third parties to independently confirm with the parties that steps or milestones associated with processing the transaction were completed. This third-party confirmation may be independent of notifications provided to the parties by the transaction service.

Referring again to FIG. 2A, in an embodiment, at 235, the transaction service optionally maintains the transaction data in the containers within the hierarchy for a configurable period of time. This allows parties to the transaction to access the transaction-related data for a set time period after the transaction is completed. For example, a warranty document, usage instructions, dosage instructions, user manuals for a product, product return policies, itemized receipts, advertisements, coupons, general contract terms, and/or rebate requirements and instructions can be accessed by a buyer for a configurable period of time after the transaction. Critical transaction details may also be acquired from either of the parties as well as through the transaction service by traversing the hierarchy of containers.

At 240, the transaction service optionally enforces access restriction(s) on requests for access to the transaction data of the containers based on access rights assigned to the containers. For example, a buyer may provide the transaction service with a buyer's subset of confidential transaction data that the buyer does not want to share with the seller, such as a home address, an email address, a phone number, etc. Likewise, the seller may provide the transaction service with specific personnel contact details for the seller that the seller does not what to share with the buyer. Other situations may arise as well when the parties submit their transaction data, at least some of which is private. That is, in example embodiments, access to one or more containers of the transaction container hierarchy may be restricted based on assigned access rights associated with the corresponding one or more containers.

In an embodiment, at 245, the transaction service optionally sends a notification to at least one of the parties when the transaction is confirmed as completed. For example, a financial network that uses a transaction clearinghouse typically only notifies the seller when a payment transaction is completed. Here, either the transaction service is the clearinghouse such that both the buyer and seller are notified, or the transaction service uses the transaction clearinghouse to process the transaction and the transaction service sends the buyer a notification when a payment transaction is completed.

FIGS. 3A, 3B, and 3C are flow diagrams of various operations that may be performed according to one or more example implementations of a method 300 of providing and operating a transaction processing service. The software module(s) that implement(s) the method 300 is referred to as a “transaction clearinghouse service.” The transaction clearinghouse service is implemented as executable instructions programmed and residing within memory and/or a non-transitory computer-readable (processor-readable) storage medium and executed by one or more processors of a device or set of devices. The processor(s) of the device that executes the transaction clearinghouse service are specifically configured and programmed to process the transaction clearinghouse service. The transaction clearinghouse service may have access to one or more network connections during its processing. The network connections can be wired, wireless, or a combination thereof.

In an embodiment, the device that executes transaction clearinghouse service is server 110. In an embodiment, the device that executes transaction clearinghouse service is a collection of servers logically cooperating as a cloud 110. In an embodiment, the device that executes the transaction clearinghouse service is transaction service server 130. In an embodiment, the transaction clearinghouse service is all of, or some combination of, 113, 114, 115, 116, 117, 133, 134, and/or method 200.

Referring now to FIG. 3A, at 310, transaction clearinghouse service organizes transaction data for a transaction between a first party and a second party into containers of a container hierarchy. The transaction clearinghouse service may receive the transaction data in a variety of manners.

For example, in an example implementation, at 311, the transaction clearinghouse service receives a first subset of the transaction data from the first party and separately receives a second subset of the transaction data from a second party. That is, the first and second parties do not have to share any private account identifiers between one another, and each party provides its own subset of transaction data for the transaction. Here, the transaction clearinghouse service links the first subset and the second subset together utilizing a transaction identifier of a transaction token that is unique to the transaction. The first party may obtain the transaction identifier from the second party in any of the manners discussed above with respect to FIG. 1B.

Referring now to FIG. 3B, in a specific implementation of 311, at 311-1, the transaction clearinghouse service receives the first subset of the transaction data in a first encrypted format from the first party and decrypts the first encrypted format before organizing the transaction data associated with the first subset in the containers of the container hierarchy. Separately, at 311-2, the transaction clearinghouse service receives the second subset of the transaction data in a second encrypted format from the second party and decrypts the second encrypted format before organizing the transaction data associated with the second subset in the containers of the container hierarchy.

Referring again to FIG. 3A, in another embodiment, at 312, the transaction clearinghouse service receives the transaction data from the first party. In this case, the second party provides a receipts-only account identifier, the transaction details, and the amount due to the first party. The first party then transmits the data provided by the second party along with the first party's private account identifier or disbursements-only account identifier to the transaction clearinghouse service utilizing interface 123, for example.

Still referring to FIG. 3A, in yet another embodiment, at 313, the transaction clearinghouse service receives the transaction data from the second party. In this case, the first party provides a disbursements-only account identifier and, optionally, a payment limit to the second party. The second party then transmits the data provided by the first party along with the second party's private account identifier or a receipts-only account identifier to the transaction clearinghouse service utilizing interface 123, for example.

Referring now to FIG. 3C, in a specific implementation of 313, and beginning at 313-1, the transaction clearinghouse service identifies a non-final invoice in an initial subset of the transaction data. At 313-2, the transaction clearinghouse service identifies a limit defined by or associated with an account of the first party in the initial subset of the transaction data. The limit can be a time limit for the invoice to be finalized or a cash amount limit that can be applied to the invoice. At 313-3, the transaction clearinghouse service iteratively receives one or more second subsets of the transaction data from the second party based on purchases or activities of the first party with the second party. At 313-4, the transaction clearinghouse service assembles a final invoice based on 313-3. At 314-5, the transaction clearinghouse service notifies the first party when the limit is exceeded or within a configurable amount of time or cash amount of the limit. This may occur during 313-3 or in connection with 313-4. At 313-6, the transaction clearinghouse service provides the final invoice to the first party for authorization at 320, as discussed below.

Referring again to FIG. 3A, at 320, the transaction clearinghouse service identifies an authorization from the first party to process the transaction. Identification of the authorization may be assumed or implicit when the transaction data is received from the first party at 312 and the transaction is not associated with any open tab.

In a particular implementation of 320, at 321, the transaction clearinghouse service identifies an invoice provided by the second party in the transaction data associated with a particular container of the container hierarchy. The transaction clearinghouse service provides the invoice in a data format that can be viewed by the first party within interface 123. The transaction clearinghouse service receives the authorization from the first party through interface 123. This is unlike conventional transactions where it is assumed that the seller has presented an invoice to buyer such that all that is needed for a transaction is an account identifier for the buyer because, according to this embodiment of the disclosed technology, the buyer has to expressly authorize the invoice before the transaction clearinghouse service processes the transaction.

Still referring to FIG. 3A, at 330, the transaction clearinghouse service obtains a portion of the transaction data from the containers of the container hierarchy. That is, as discussed above with system 1008 and method 200, only the transaction data necessary to process the transaction on behalf of the parties may be obtained from the container hierarchy. Other portions of the transaction data not necessary for the transaction to be processed may remain securely stored within the container hierarchy.

At 340, the transaction clearinghouse service causes the transaction to be processed on behalf of the parties using the portion of transaction data obtained at 330. The transaction clearinghouse service may use other clearinghouses to perform portions of the transaction, in which case, transaction clearinghouse service may utilize APIs 114 and 134 to interact with the corresponding service 133. It may also be that the transaction clearinghouse service processes the transaction entirely on its own using a financial network without the assistance of any other service 133.

At 350, the transaction clearinghouse service causes a confirmation indicating that the transaction was completed to be sent to at least the first party. If the transaction clearinghouse service does not use any outside service to process the transaction, then the transaction clearinghouse service may notify both the first and second parties that the transaction completed. If the transaction clearinghouse service utilizes a service 133 to complete one or more portions of the transaction, then the transaction clearinghouse service notifies the party that did not require use of the service 133 that the transaction completed (e.g., first party when the seller's service 133 is used to process the transaction).

In an embodiment, at 360 (shown in FIG. 3A), the transaction clearinghouse service maintains a first encryption/decryption key for the transaction data of the first party and maintains a second encryption/decryption key for the transaction data of the second party. The transaction clearinghouse service may encrypt the keys using a third encryption/decryption key and may store the encrypted keys within a particular container of the container hierarchy. This may be an instance when the transaction clearinghouse service is housing some portion of the transaction data in trust for the two parties, keys of both parties are required to decrypt the corresponding data of the parties, and the keys are held in escrow by the transaction clearinghouse service on behalf of the parties. The transaction clearinghouse service may also receive a portion of the transaction data in the encrypted format from one or more of the parties and store that encrypted data within the container hierarchy on behalf of the parties. It may also be that each party wants its data encrypted in a specific format requiring a specific key, such that the transaction clearinghouse service maintains the keys within the hierarchy to encrypt that data as needed when servicing the parties. In an embodiment, the keys may be time-dependent and dynamically-generated keys. For example, private account identifiers may be transmitted in an encrypted format based on a variety of dynamic factors such as timestamp, transaction identifier, and/or rolling codes (e.g., similar to garage door opener signals, etc.) to ensure uniqueness of each encryption of the private account identifier. The party encrypting the data may use a same time-based or factor-based dynamic encryption algorithm as transaction clearinghouse service does so that the transaction clearinghouse service can decrypt the data once received. In this manner, fraud potential of a criminal who submits encrypted data with the intent to steal is minimized.

It should be appreciated that where software is described herein in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other suitable manner.

Furthermore, although the software modules are illustrated as executing on one piece of hardware, the software may be distributed over multiple processors or in any other suitable manner. The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving, by a transaction processing server, transaction data associated with parties to a transaction, the parties including a first party and a second party;
parsing, by the transaction processing server, the transaction data into one or more containers having an associated hierarchy, wherein parsing further includes decrypting separately supplied and received portion of the transaction data from each party and maintaining decryption keys held by the transaction processing and not by the parties; and
processing the transaction on behalf of the parties using the transaction data corresponding to one or more selected containers of the hierarchy of containers.

2. The method of claim 1 further comprising:
maintaining the transaction data in the one or more containers of the hierarchy for a configurable period of time after the processing of the transaction is complete.

3. The method of claim 2 further comprising:
enforcing access restrictions on requests for access to the transaction data of the one or more containers based on access rights assigned to the one or more containers.

4. The method of claim 1 further comprising:
sending notification to at least one of the parties when the transaction is confirmed as completed.

5. The method of claim 1, wherein receiving further includes:
receiving a first subset of the transaction data from the first party, the first subset including a first transaction identifier;
separately receiving a second subset of the transaction data from the second party, the second subset including a second transaction identifier;
determining that the first transaction identifier matches the second transaction identifier; and
based on determining that the first transaction identifier matches the second transaction identifier, combining the first subset of the transaction data with the second subset of the transaction data to form the transaction data for the transaction.

6. The method of claim 5, wherein receiving the first subset of the transaction data further includes decrypting the first subset of the transaction data using a private key of a transaction service and a public key of the first party.

7. The method of claim 6, wherein separately receiving further includes decrypting the second subset of the transaction data using the private key of the transaction service and a public key of the second party.

8. The method of claim 7, wherein parsing further includes encrypting at least a portion of the transaction data within at least one corresponding container.

9. The method of claim 1, wherein parsing further includes:
identifying an invoice from the transaction data provided by the first party to the transaction; and
providing the invoice for approval to the second party of the transaction before the processing.

10. The method of claim 1, wherein processing further includes:
verifying a total amount due for an invoice sent by the first party in a first subset of the transaction data matches or is less than an authorized payment amount sent by the second party in a second subset of the transaction data before completing the transaction on behalf of the parties.

11. The method of claim 1, wherein processing further includes:
requesting a third-party service process the transaction using the transaction data from the one or more selected containers; and
requesting the third-party service notify each of the first party and the second party when the transaction is completed by the third-party service.

12. The method of claim 1, wherein processing further includes:
notifying, by a transaction service, one or more third-party services as different portions of a workflow associated with processing the transaction are completed such that the one or more third-party services can confirm completion of the different portions of the workflow with the parties independently of the transaction service.

13. A method, comprising:
organizing, by a transaction clearinghouse server, separately received portions of transaction data for a transaction between a first party and a second party into containers of a container hierarchy, wherein each container comprises a respective portion of the transaction data with a corresponding container-defined data format and container-defined access rights and maintaining decryption keys to decrypt and to process the separately received portions on the transaction clearinghouse server, wherein the decryption keys are not held by the first party and not held by the second party;
identifying an authorization from the first party to process the transaction;
obtaining, by the transaction clearinghouse server, a first portion of the transaction data from the containers of the container hierarchy;
causing the transaction to be processed on behalf of the parties using the first portion of the transaction data; and
causing a confirmation indicating that the transaction was completed to be sent to at least the first party.

14. The method of claim 13, where organizing further includes one of:
receiving a first subset of the transaction data from the first party and separately receiving a second subset of the transaction data from the second party;
receiving the transaction data from the first party;
or receiving the transaction data from the second party.

15. The method of claim 14, wherein receiving the first subset and the second subset of the transaction data further includes:
receiving the first subset of the transaction data in a first encryption format from the first party and decrypting the first encrypted format; and
separately receiving the second subset of the transaction data in a second encrypted format from the second party and decrypting the second encrypted format.

16. The method of claim 14, wherein receiving the transaction data from the second party further includes:
identifying a non-final invoice in an initial subset of the transaction data;
identifying a limit defined by or associated with an account of the first party in the initial subset of the transaction data;
iteratively receiving one or more second subsets of the transaction data from the second party;
assembling a final invoice based on the iteratively receiving;
notifying the first party when the limit is exceeded or within a configurable amount of the limit; and
providing the final invoice to the first party for the authorization.

17. The method of claim 13, wherein identifying further includes:
identifying an invoice provided by the second party in the transaction data associated with a particular container of the container hierarchy;
providing the invoice in a data format that can be viewed by the first party within an interface; and
receiving the authorization from the first party through the interface.

18. The method of claim 13 further comprising:
maintaining a first encryption/decryption key for the transaction data associated with the first party;
maintaining a second encryption/decryption key for the transaction data associated with the second party; and
encrypting the first encryption/decryption key and the second encryption/decryption key using a third encryption/decryption key and inserting an encrypted version of the first encryption/decryption key and the second encryption/decryption key within a particular container of the container hierarchy.

19. A system, comprising:
a server comprising at least one processor and a non-transitory computer-readable storage medium;
the non-transitory computer-readable storage medium comprising server executable instructions;
the server executable instructions cause the at least one processor of the server to perform operations comprising:
identifying, by the server, a transaction between a first party and a second party;
identifying transaction data associated with the transaction by receiving separate portions of the transaction data from the first party and the second party and maintaining decryption keys held by the transaction processing and not by the first party and not by the second party;
segmenting, by the server, the transaction data into containers having a corresponding container hierarchy, wherein the containers comprise different data formats, encodings, or encryptions for the transaction data, and wherein the containers comprise different access rights for accessing the corresponding containers;
receiving authorization from the first party to process the transaction;
causing the transaction to be completed on behalf of the first party and the second party; and
causing a notification to be sent to at least the first party when the transaction is completed.

20. The system of claim 19, wherein the server executable instructions, when executed by the at least one processor, further cause the at least one processor to perform additional operations comprising:
providing select transaction data to at least one of the parties after the transaction is completed for a configurable period of time based on the corresponding access rights associated with the corresponding containers of the container hierarchy.
